(19) United States
(12) Patent Application Publication
(10) Pub. No.: US 2025/0155270 A1
(43) Pub. Date: May 15, 2025

(54) SYSTEM AND MANIPULATION PATH FOR MONITORING THE FLOW PROFILE AT THE INLET OF A FLOW SENSOR

(71) Applicant: Innovative Sensor Technology IST AG, Ebnat-Kappel (CH)

(72) Inventors: Ralf Emanuel Bernhardsgrütter, Sulgen (CH); Christof Huber, Bern (CH); Florian Krogmann, Kreuzlingen (CH)

(21) Appl. No.: 18/839,208

(22) PCT Filed: Jan. 23, 2023
(86) PCT No.: PCT/EP2023/051483

§ 371 Date: Aug. 16, 2024

(30) Foreign Application Priority Data
Feb. 18, 2022 (DE) 10 2022 103 952.8

(51) Int. Cl. G01F 1/684

(52) U.S. Cl. CPC G01F 1/6842

(57) ABSTRACT

A manipulation path for monitoring the flow profile at the inlet of a flow sensor, the manipulation path designed to conduct a fluid measuring medium, includes a first end region and a second end region, between which a manipulation section is located that is designed such that secondary flows are formed in the measuring medium as a result of the measuring medium flowing through the manipulation section. Two different variants of a system, each including a flow sensor and the manipulation path according to the present disclosure, are disclosed.

The invention relates to a manipulation path for monitoring the flow profile at the inlet of a flow sensor. The invention further relates to two different variants of a system, each variant comprising a flow sensor and the manipulation path according to the invention.

Flow sensors are used for determining a flow rate or the flow velocity of a measuring medium, or a fluid, e.g., a gas, a gas mixture, or a liquid. There are various types of flow sensors, for example, thermal flow sensors, Coriolis flow sensors, ultrasonic flow sensors, microwave flow sensors, etc.

Thermal flow sensors, for example, make use of the fact that a (flowing) measuring medium transports heat away from a heated surface. Thermal flow sensors are typically composed of several functional elements, usually at least one low-impedance heating element and one high-impedance resistance element, which serve as a temperature sensor. Alternatively, thermal flow sensors are composed of several low-impedance heating elements, serving as heaters and temperature sensors.

The performance of flow sensors, in particular in the case of thermal flow sensors, can be dependent on the inlet condition of the measuring medium. For example, it makes a difference whether the measuring medium flows into the flow sensor straight or at a 90° angle. Depending on the inlet condition, this can lead to a significant change in the measuring signal which can result in a large inaccuracy during application.

There are only a few options to prevent this. The following options are known from the prior art, for example:

The inlet of the flow sensor or to the flow sensor is designed as a long path. As a result, the flow profile can fully develop in the course of the path. However, a lot of space is required for this option.

The inlet path, designed for example as an inlet tube, can have “dents” on the walls, which ensure that the flow profile becomes turbulent. This solution is used, for example, in the OmniFIN HFK35 made by GMH Group—Honsberg. The disadvantage of this method is that the signal noise increases greatly.

Both solutions are thus impractical for many applications.

Given this problem, the object of the invention is to reduce a flow sensor's inlet dependence.

This object is achieved by a manipulation path according to claim 1, by a system according to claim 5 and by a system according to claim 7.

As regards the manipulation path, it is used for monitoring the flow profile at the inlet of a flow sensor. The manipulation path is designed to conduct a fluid measuring medium, and the manipulation path has a first end region and a second end region, between which a manipulation section is located that is designed such that secondary flows are formed in the measuring medium as a result of the measuring medium flowing through the section.

The manipulation path is designed such that it forms secondary flows at least in the region of the manipulation section. Secondary flow means an additional, low-velocity flow in the plane transverse to the main flow direction. This results in the flow profile being steadied and developing largely independently of the flow velocity. The performance of the flow sensor and its dynamic range is thereby increased. Furthermore, inlet dependence of the flow sensor is drastically reduced. The other disadvantages listed in the introductory part of the description are reduced or completely eliminated.

According to an advantageous embodiment of the manipulation path according to the invention, it is provided for the manipulation path to be tubular, i.e., in the form of a tube. In principle, any material, for example, a plastic or a metal, can be used for this purpose.

A particularly advantageous embodiment of the manipulation path according to the invention provides for the manipulation path to be curved helically with at least one full revolution in the manipulation section. It has been found that the helical shape provides an ideal ratio between low space requirement and high effectiveness in generating the secondary flows.

One advantageous embodiment of the manipulation path according to the invention provides for the manipulation path to have a tube diameter and a helical diameter, wherein the ratio of the tube diameter to the helical diameter is greater than 0.01. Such a ratio leads to an increase in the critical Reynolds number by the factor two.

Alternatively, other embodiments of the manipulation section are provided which generate sufficient secondary flows. For example, instead of the tube being helically curved, a tube insert with a, for example, helical design can be inserted into the tubular manipulation section.

As regards the system, it comprises in a first variant:
a flow sensor for detecting at least one parameter relating to the flow rate of a fluid measuring medium;
a manipulation path according to the invention, wherein the second end region of the inlet tube is connected to the intake of the thermal flow sensor.

In the first variant, the manipulation path is upstream of the flow sensor. This involves, in particular, two separate components which are connected to one another.

According to an embodiment of the first variant of the system according to the invention, the system further comprises a primary pipe through which the measuring medium flows, wherein the manipulation path is connected to the pipe at the first end region, wherein an outlet of the flow sensor is connected to the pipe.

As regards the system, it comprises in a first variant:
a flow sensor for detecting at least one parameter relating to the flow rate of a fluid measuring medium;
a manipulation path according to the invention, wherein the flow sensor is integrated in the manipulation path, and wherein the flow sensor is arranged between the end of the manipulation path and the second end region.

In the second variant, the flow sensor is located in the manipulation path.

According to an embodiment of the second variant of the system according to the invention, the system further comprises a primary pipe through which the measuring medium flows, wherein the manipulation path is connected to the pipe at the first end region, and wherein the manipulation path is connected to the pipe at the second end region.

In both variants, it can be provided for the flow sensor to form a bypass to the primary pipe together with the manipulation path. This means that the medium flow through the primary pipe is not interrupted and that the measuring medium flows through the manipulation path and the flow sensor parallel to the primary pipe.

Alternatively, it is provided for the primary pipe to end at the first end region of the manipulation path and at the second end region of the manipulation path or at the outlet of the flow sensor (depending on the variant of the system), so that there is no parallel medium flow and the measuring medium flows exclusively through the manipulation path and the flow sensor.

According to one embodiment of the first or second variant of the system according to the invention, it is provided for the flow sensor to be a thermal flow sensor. Various variants of thermal flow sensors having different types of action and designs are known from the prior art:

Calorimetric thermal flow sensors determine the flow or flow rate of the fluid in a channel by way of a temperature difference between two temperature sensors, which are arranged downstream and upstream of a heating element. For this purpose, use is made of the fact that, up to a certain point, the temperature difference is linear with respect to the flow or the flow rate. This procedure or method is described extensively in the relevant literature.

Anemometric thermal flow sensors consist of at least one heating element, which is heated during the measurement of the flow. As a result of the measuring medium flowing around the heating element, heat transport into the measuring medium takes place, which changes with the flow velocity. The flow velocity of the measuring medium can be inferred by measuring the electrical variables of the heating element.

Such an anemometric thermal flow sensor is typically operated in one of the following two modes: in the “constant current anemometry” (CCA) mode, a constant current is applied to the heating element. The measuring medium flowing around causes the resistance of the heating element to change, and thus the voltage to drop at the heating element, which represents the measuring signal. The “constant voltage anemometry” (CVA) control type functions similarly thereto, with a constant voltage being applied to the heating element.

In the “constant temperature anemometry” (CTA) control type, the heating element is maintained at a temperature that, on average, is constant. Relatively high flow velocities can be measured by means of this control type. Depending upon the flow velocity, more or less heat is transported away by means of the flowing measuring medium, and, accordingly, more or less electrical power must be fed in in order to keep the temperature constant. This fed-in electrical power is a measure of the flow velocity of the measuring medium.

However, the system according to the invention can also be operated with other types of thermal flow sensors for which a flow profile that is stable over the flow velocity is advantageous. For example, other types of flow sensors can also be used, for example Coriolis flow sensors, ultrasonic flow sensors or microwave flow sensors.

The invention is explained in greater detail with reference to the following figures. In the figures:

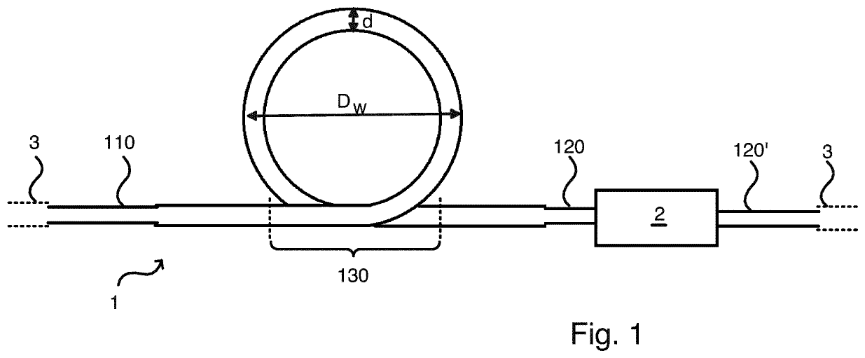

FIG. 1: shows a schematic representation of a design of a manipulation path according to the invention and its use in one application;

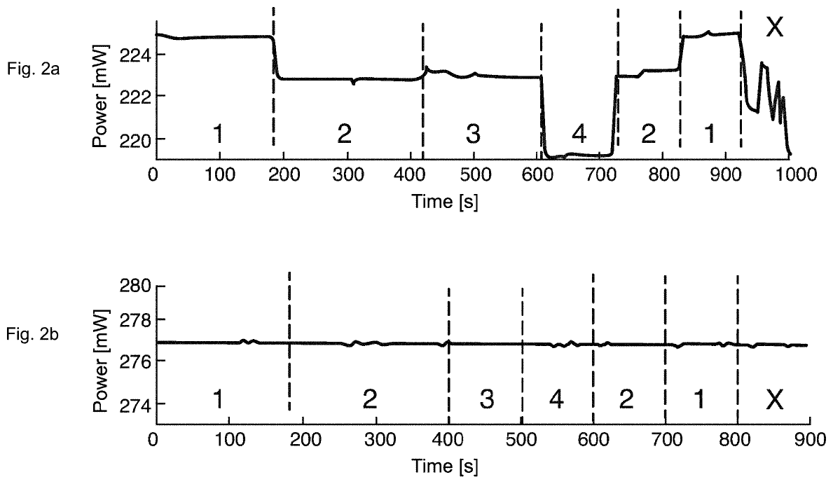

FIG. 2: shows measured values of a thermal flow sensor for different inlet conditions, without and with using a manipulation path according to the invention; and

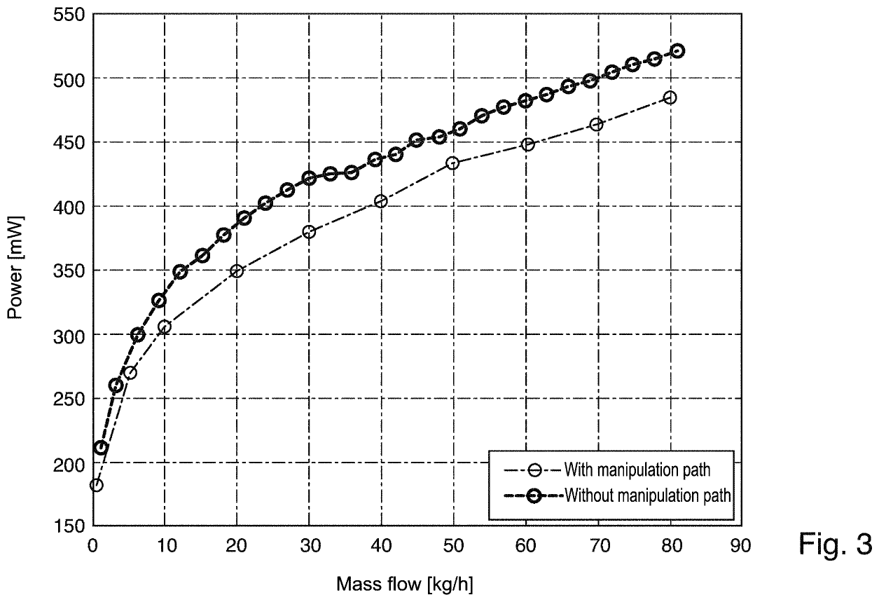

FIG. 3: shows measured values of a thermal flow sensor at different flow rates of the measuring medium, without and with using a manipulation path according to the invention.

FIG. 1 shows a design which is to improve the flow dependence of the inlet of a flow sensor 2. A manipulation path 1 is used. It has a manipulation section 130 which manipulates a measuring medium flowing through it such that the dependence of the flow profile of the measuring medium at the inlet of the flow sensor 2 is essentially decoupled from the flow velocity over a large value range of the flow velocity. In the present case, the flow sensor 2 is a thermal flow sensor. However, other types of flow sensors can also be advantageously used.

For this purpose, the flow sensor 2 is connected to the manipulation path 1. Either the intake of the thermal flow sensor 2 is connected to a second end region 120 of the manipulation path 1. Alternatively, the thermal flow sensor 2 is part of the manipulation path 1 or is integrated therein. This combination of manipulation path and flow sensor is then connected to a primary pipe 3 through which the measuring medium flows.

It can be provided for the combination of manipulation path and flow sensor to form a bypass to the primary pipe 3. This means that the medium flow through the primary pipe 3 is not interrupted and that the measuring medium flows through the manipulation path 1 and the flow sensor 2 parallel to the primary pipe.

Alternatively, it is provided for the primary pipe 3 to end at the first end region of the manipulation path and at the second end region of the manipulation path or at the outlet of the flow sensor (depending on the variant of the system), so that there is no parallel medium flow and the measuring medium flows exclusively through the manipulation path 1 and the flow sensor 2.

One solution to an embodiment of the manipulation section 130 is a helical curvature as shown in FIG. 1. Experimental tests have shown that the inlet dependence of a flow sensor 2 having such an upstream manipulation section as an inlet path is drastically reduced compared to conventional flow sensors.

FIG. 2 shows experimental data collected for this purpose. Diagrams (a) and (b) represent a course of the current measured values of the flow sensor 2 (in mW, y-axis) over time (in seconds, x-axis). The flow value of the measuring medium is kept constant. The inlet condition of the measuring medium in the flow sensor 2 is changed several times over time. For this purpose, the end region of the pipe is changed, which is connected directly to the flow sensor (diagram (a)) or to the manipulation path (according to FIG. 1, diagram (b)). A lateral, “S”-shaped inlet is used in the two time intervals “2.” An angled inlet with a 90° curve is used in time interval “3.” An “S”-shaped inlet from below is used in time interval “4.” The inlet is continuously changed manually in time interval “X.”

Diagram (a) lists the measured values of a flow sensor which is operated conventionally, i.e., is connected to the primary pipe 3 without the manipulation path 1 according to the invention. It is obvious that the profile of the end region of the primary pipe 3 has a great influence on the measured values of the flow sensor 2, even if the magnitude of the flow velocity is not changed.

In diagram (b), the manipulation path 1 is located between the variable end region of the primary pipe 3 and the flow sensor 2, as shown in FIG. 1. Now, a dependence between the design of the end region of the primary pipe 3 and the measured values of the flow sensor can no longer be seen. The measured values of the flow sensor 2 are independent of the inlet conditions.

In addition to these findings, it has also been found in the experiments that the signal noise of the flow sensor 2 is reduced. This is due to the so-called secondary flows which form when the measuring medium flows into the manipulation section 130. This reduction in signal noise has a direct influence on the sensor performance because it increases sensitivity of the flow sensor 2.

It was also possible to show that the switch from laminar to turbulent flow is pushed massively toward greater flow rates. This can also be explained by theory. The critical Reynolds number is approximately 2300 for conventional tube flows. The following formula applies to a helical shape as shown in FIG. 1:

$${Re}_{k} = 2300 \cdot ( 1 + 86 \cdot {( \frac{d}{D} )}^{0.45} )$$

$$with$$

$$D = {D}_{w} \cdot ( 1 + {( \frac{h}{π \cdot {D}_{w}} )}^{2} )$$

Here, Reₖ denotes the critical Reynolds number at which a switch from laminar to turbulent flow takes place. D_{w} denotes the helical diameter, d denotes the tube diameter, and h denotes the distance between the tubes.

For a helical design of the manipulation section 130 with a helical diameter of D_{W}=30 mm, a tube diameter d=3.7 mm, and a distance between the tubes h=4 mm, the formula results in a critical Reynolds number of 10,300. The laminar region is thus greater by a factor 4 than in a conventional (straight) inlet path. For the flow sensor 2, this means that the measuring range can be increased by said factor.

Advantageously, the ratio of tube diameter d helical diameter D_{W} is greater than 0.01; the factor is thus at least 2.

FIG. 3 shows experimental tests related to the switch from laminar to turbulent flow. The dependence on the sensor measured values (in mW, y-axis) in relation to the present mass flow of the measuring medium (in kg/h, x-axis) is shown. The upper curve (in terms of higher measured values) shows this dependence when using a conventional flow sensor without an interposed manipulation path 1.

A switch from laminar to turbulent flow can be seen at a mass flow value of approximately 25 kg/h. The lower curve (in terms of lower measured values) shows this dependence with the manipulation path 1 interposed, in terms of the design as shown in FIG. 1. Here, no clear switch can be seen over the entire measuring span (up to 80 kg/h), which confirms the above-described increase in the critical Reynolds number.

In summary, the use of a manipulation path 1 according to the invention in conjunction with a flow sensor 2 has the following advantages:
the inlet dependence of the flow sensor is clearly reduced;
the laminar flow region is increased;
external noise is attenuated;
space-saving compared to previous solutions.

Other embodiments of the manipulation section 130, apart from a helix, can also be used. For example, instead of the manipulation section 130 being helically curved, a tube insert with a, for example, helical design can be inserted into the tubular manipulation section 130.

### LIST OF REFERENCE SIGNS

1 Manipulation path
110 First end region
120, 120′ Second end region
130 Manipulation section
2 Flow sensor
3 Primary pipe
d Tube diameter
D_{w} Helical diameter

1-9. (canceled)

10. A manipulation path for monitoring the flow profile at the inlet of a flow sensor, wherein the manipulation path is configured to conduct a fluid measuring medium flowing therethrough, the manipulation path comprising:
a first end region, a second end region, and a manipulation section disposed between the first end region and a second end region of the manipulation path,
wherein the manipulation section is configured such that secondary flows are formed within the measuring medium due to the measuring medium flowing through the manipulation section.

11. The manipulation path according to claim 10, wherein the manipulation path is tubular.

12. The manipulation path according to claim 11, wherein the manipulation path is curved helically with at least one full revolution in the manipulation section.

13. The manipulation path according to claim 12, wherein the manipulation path has a tube diameter, and the at least one full revolution has a helical diameter, wherein a ratio of the tube diameter to the helical diameter is greater than 0.01.

14. A system, comprising:
a flow sensor configured to detect at least one parameter relating to the flow rate of a fluid measuring medium; and
the manipulation path according to claim 10, wherein the second end region of the manipulation path is connected to an intake of the flow sensor.

15. The system according to claim 14, further comprising a primary pipe through which the measuring medium flows, wherein the first end region of the manipulation path is connected to the primary pipe, and wherein an outlet of the flow sensor is connected to the primary pipe.

16. The system according to claim 14, wherein the first end region of the manipulation path is configured to be connected to a first section of a primary pipe through which the measuring medium flows, and wherein an outlet of the flow sensor is connected to a second section of the primary pipe.

17. The system according to claim 14, wherein the flow sensor is a thermal flow sensor.

18. The system, comprising:
a flow sensor configured to detect at least one parameter relating to the flow rate of a fluid measuring medium; and
the manipulation path according to claim 10, wherein the flow sensor is integrated in the manipulation path, and wherein the flow sensor is disposed between an end of the manipulation section and the second end region of the manipulation path.

19. The system according to claim 18, further comprising a primary pipe through which the measuring medium flows, wherein the first end region of the manipulation path is connected to the primary pipe, and wherein the manipulation path is connected to the primary pipe at the second end region.

20. The system according to claim 18, wherein the first end region of the manipulation path is configured to be connected to a first section of a primary pipe through which the measuring medium flows, and wherein the second end region of the manipulation path is connected to a second section of the primary pipe.

21. The system according to claim 18, wherein the flow sensor is a thermal flow sensor.
